(19) United States
(12) Patent Application Publication
(10) Pub. No.: US 2013/0206117 A1
(43) Pub. Date: Aug. 15, 2013

(54) EXHAUST GAS RECIRCULATION APPARATUS FOR ENGINE

(71) Applicant: AISAN KOGYO KABUSHIKI KAISHA, (US)

(72) Inventors: Keiso TAKEDA, Nagoya-shi (JP); Yukiya KATO, Nagoya-shi (JP); Kazumasa NAKASHIMA, Nagoya-shi (JP)

(73) Assignee: AISAN KOGYO KABUSHIKI KAISHA, Obu-shi (JP)

(21) Appl. No.: 13/750,688

(22) Filed: Jan. 25, 2013

(30) Foreign Application Priority Data
Feb. 14, 2012 (JP) 2012-029498

(51) Int. Cl. F02M 25/07

(52) U.S. Cl. CPC F02M 25/077
USPC 123/559.1; 123/568.2

(57) ABSTRACT

An exhaust gas recirculation apparatus for engine includes an EGR passage, a first EGR valve and a second EGR valve provided in series in the EGR passage to regulate an EGR flow rate in the EGR passage. The first EGR valve is configured as a poppet valve and is configured to open in a range of opening degree from full open to full close. The second EGR valve has a maximum opening degree restricted to a predetermined small opening degree smaller than full open. The second EGR valve is configured to open in a range of opening degree from the predetermined small opening degree to full close and to allow the first EGR valve to provide a maximum exhaust flow rate when the second EGR valve is held at the predetermined small opening degree.

### CROSS-REFERENCE TO RELATED APPLICATIONS

This application is based upon and claims the benefit of priority from each of the prior Japanese Patent Application No. 2012-029498 filed on Feb. 14, 2012, the entire contents of which are incorporated herein by reference.

### TECHNICAL FIELD

The present invention relates to an exhaust gas recirculation apparatus for engine to allow a part of exhaust gas discharged from the engine to flow in an exhaust passage and recirculate back into the engine.

### BACKGROUND ART

The above type of technique is heretofore used in a vehicle engine, for example. An exhaust gas recirculation (EGR) apparatus is configured such that a part of exhaust gas discharged from a combustion chamber of an engine to an exhaust passage after combustion is introduced as EGR gas into an intake passage through an EGR passage, and then mixed with intake air flowing in the intake passage, and this mixture recirculates back into a combustion chamber. The EGR gas flowing in the EGR passage is regulated by an EGR valve provided in the EGR passage. This EGR can mainly reduce nitrogen oxide (NOx) in the exhaust gas and improve fuel consumption while the engine is subjected to partial load.

The exhaust gas from the engine contains no or little oxygen. Accordingly, when a part of exhaust gas is mixed with intake air by EGR, the concentration of oxygen in the intake air becomes lower. In the combustion chamber, therefore, a fuel burns in a low oxygen concentration state. This can decrease a peak temperature during combustion, thereby restraining the generation of NOx. In a gasoline engine, the EGR can prevent the oxygen content in the intake air from increasing and thus reduce a pumping loss of the engine even when a throttle valve is in to some extent closed state.

Herein, for further improvement of fuel consumption of an engine, it is recently conceived to perform EGR in every engine operating region. This requires the realization of high EGR. To realize the high EGR, it is necessary to remodel a conventional apparatus by increasing an inner diameter of the EGR passage or increasing the size (diameter) of a valve element and the area of a flow path opening of a valve seat of an EGR valve.

Furthermore, Patent Documents 1 to 3 listed below each disclose an EGR apparatus in which two EGR valves are arranged in series in an EGR passage in order to improve controllability of EGR. For example, the EGR apparatus disclosed in Patent Document 1 includes an EGR passage connecting an exhaust system and an intake system in an engine to recirculate a part of exhaust gas back into the intake system, an EGR mechanism including an EGR valve provided in the EGR passage, EGR-mechanism actuating means configured to drive the EGR valve to open or close according to an operating state of the engine to actuate the EGR mechanism, and a flow control valve provided in the EGR passage and operable with higher response as compared with the EGR valve. When an engine combustion pattern is changed over from stratified charge combustion to premix combustion, and vice versa, the EGR-mechanism actuating means drives the EGR valve and the flow control valve to open or close to actuate the EGR mechanism. Accordingly, this technique, in the engine having different combustion patterns, is intended to improve the EGR mechanism, achieve an EGR amount just enough for a combustion state, prevent accident fire, and also prevent a decrease in driveability, a decrease in emission performance, and others.

### CITATION LIST

### Patent Literature

Patent Document 1: JP-A-2000-345923

Patent Document 2: JP-A-2006 -329039

Patent Document 3: JP-A-63(1988)-198766

### SUMMARY OF INVENTION

### Technical Problem

Meanwhile, it is conceivable to arrange the EGR apparatus disclosed in Patent Document 1 to treat the high EGR. For this purpose, the diameter of the EGR passage is increased and the valve element and the valve seat of the EGR valve are upsized. However, such an arrangement for high EGR needs to enhance valve-closing response of the flow control valve having a higher response characteristic as compared with a response characteristic of the EGR valve in order to restrain accidental fire of the engine during deceleration. Accordingly, a drive mechanism (e.g., a motor) of the flow control valve requires a size increase for high output power. This may cause restriction on its mountability on a vehicle or increase in manufacturing cost.

The present invention has been made in view of the above circumstances and has a purpose to provide an exhaust gas recirculation apparatus for engine, including a first exhaust gas recirculation valve and a second exhaust gas recirculation valve provided in series in an exhaust gas recirculation passage to precisely regulate a flow rate of exhaust gas in the exhaust gas recirculation passage, and also promptly shut off an exhaust gas recirculating flow during engine deceleration, thereby restraining upsizing of a drive mechanism and enhancing drive power for the second exhaust recirculation valve.

### Solution to Problem

To achieve the above purpose, one aspect of the invention provides an exhaust gas recirculation apparatus for engine comprising: an exhaust gas recirculation passage for allowing a part of exhaust gas discharged from a combustion chamber of an engine to an exhaust passage to flow in an intake passage and recirculate to the combustion chamber; and a first exhaust gas recirculation valve and a second exhaust gas recirculation valve provided in series in the exhaust gas recirculation passage to regulate a flow rate of the exhaust gas in the exhaust gas recirculation passage, wherein the first exhaust gas recirculation valve is configured as a poppet valve and is configured to open in a range of opening degree from full open to full close, and the second exhaust gas recirculation valve has a maximum opening degree restricted to a predetermined small opening degree smaller than full open and is configured to open in a range of opening degree from the predetermined small opening degree to full close.

Another aspect of the invention provides an exhaust gas recirculation apparatus for engine comprising: an exhaust gas recirculation passage for allowing a part of exhaust gas discharged from a combustion chamber of an engine to an exhaust passage to flow in an intake passage and recirculate to the combustion chamber; and a first exhaust gas recirculation valve and a second exhaust gas recirculation valve provided in series in the exhaust gas recirculation passage to regulate a flow rate of the exhaust gas in the exhaust gas recirculation passage, wherein the first exhaust gas recirculation valve is configured as a poppet valve and is configured to open in a range of opening degree from full open to full close, the second exhaust gas recirculation valve has a maximum opening degree restricted to a predetermined small opening degree smaller than full open and is configured to open in a range of opening degree from the predetermined small opening degree to full close, the second exhaust gas recirculation valve is configured to allow the first exhaust gas recirculation valve to provide a maximum exhaust flow rate when the second exhaust gas recirculation valve is at the predetermined small opening degree the second exhaust gas recirculation valve includes a butterfly valve, the first exhaust gas recirculation valve is placed more downstream than the second exhaust gas recirculation valve in the exhaust gas recirculation passage, a supercharger is provided in a position between a portion of the intake passage and a portion of the exhaust passage, a throttle valve is provided in the intake passage downstream from the supercharger, and the exhaust gas recirculation passage has an inlet connected to the exhaust passage upstream from the supercharger and an outlet connected to the intake passage downstream from the throttle valve.

Still another aspect of the invention provides an exhaust gas recirculation apparatus for engine comprising: an exhaust gas recirculation passage for allowing a part of exhaust gas discharged from a combustion chamber of an engine to an exhaust passage to flow in an intake passage and recirculate to the combustion chamber; and a first exhaust gas recirculation valve and a second exhaust gas recirculation valve provided in series in the exhaust gas recirculation passage to regulate a flow rate of the exhaust gas in the exhaust gas recirculation passage, wherein the first exhaust gas recirculation valve is configured as a poppet valve and is configured to open in a range of opening degree from full open to full close, the second exhaust gas recirculation valve has a maximum opening degree restricted to a predetermined small opening degree smaller than full open and is configured to open in a range of opening degree from the predetermined small opening degree to full close, the second exhaust gas recirculation valve is configured to allow the first exhaust gas recirculation valve to provide a maximum exhaust flow rate when the second exhaust gas recirculation valve is at the predetermined small opening degree, the second exhaust gas recirculation valve includes a butterfly valve, the first exhaust gas recirculation valve is placed more downstream than the second exhaust gas recirculation valve in the exhaust gas recirculation passage, a supercharger is provided in a position between a portion of the intake passage and a portion of the exhaust passage, a throttle valve is provided in the intake passage downstream from the supercharger, an exhaust catalyst is provided in the exhaust passage downstream from the supercharger, and the exhaust gas recirculation passage has an inlet connected to the exhaust passage downstream from the exhaust catalyst and an outlet connected to the intake passage upstream from the supercharger.

### Advantageous Effects of Invention

According to the present invention, an exhaust gas recirculation apparatus for engine, including a first exhaust gas recirculation valve and a second exhaust gas recirculation valve provided in series in an exhaust gas recirculation passage can precisely regulate a flow rate of exhaust gas in the exhaust gas flow passage, and also promptly shut off an exhaust gas recirculating flow during engine deceleration. This can restrain upsizing of a drive mechanism and enhancing drive power for the second exhaust recirculation valve.

### BRIEF DESCRIPTION OF DRAWINGS

FIG. 1 is a schematic configuration view of an engine system with a supercharger, including an engine exhaust gas recirculation apparatus (an EGR apparatus) in a first embodiment;

FIG. 2 is an enlarged cross sectional view of a part of an EGR passage in which a first EGR valve and a second EGR valve are provided;

FIG. 3 is a flowchart showing one example of processing contents of EGR control in the first embodiment;

FIG. 4 is a graph showing a relationship between opening degree and stroke of the first EGR valve, opening degree and stroke of the second EGR valve, and an EGR flow rate in the first embodiment;

FIG. 5 is an enlarged cross sectional view of a part of an EGR passage in which a first EGR valve and a second EGR valve are provided in a second embodiment;

FIG. 6 is a schematic configuration view of an engine system with a supercharger, including an engine EGR apparatus in a third embodiment;

FIG. 7 is an enlarged cross sectional view of a part of the EGR passage in which a first EGR valve and a second EGR valve are provided in the third embodiment;

FIG. 8 is a flowchart showing one example of processing contents of EGR control in the third embodiment;

FIG. 9 is an opening degree map showing a relationship of a target opening degree of the second EGR valve according to a target opening degree of the first EGR valve in the third embodiment;

FIG. 10 is a graph showing a relationship between opening degree and stroke of the first EGR valve, opening degree and stroke of the second EGR valve, and an EGR flow rate in the third embodiment;

FIG. 11 is an enlarged cross sectional view of a part of an EGR passage in which a first EGR valve and a second EGR valve are provided in a fourth embodiment;

FIG. 12 is a schematic configuration view of an engine system with a supercharger, including an engine EGR apparatus in a fifth embodiment; and

FIG. 13 is an enlarged cross sectional view of a part of an EGR passage in which a first EGR valve and a second EGR valve are provided in another embodiment.

### DESCRIPTION OF EMBODIMENTS

### First Embodiment

A detailed description of a first preferred embodiment of an exhaust gas recirculation apparatus for engine embodying the present invention will now be given referring to the accompanying drawings.

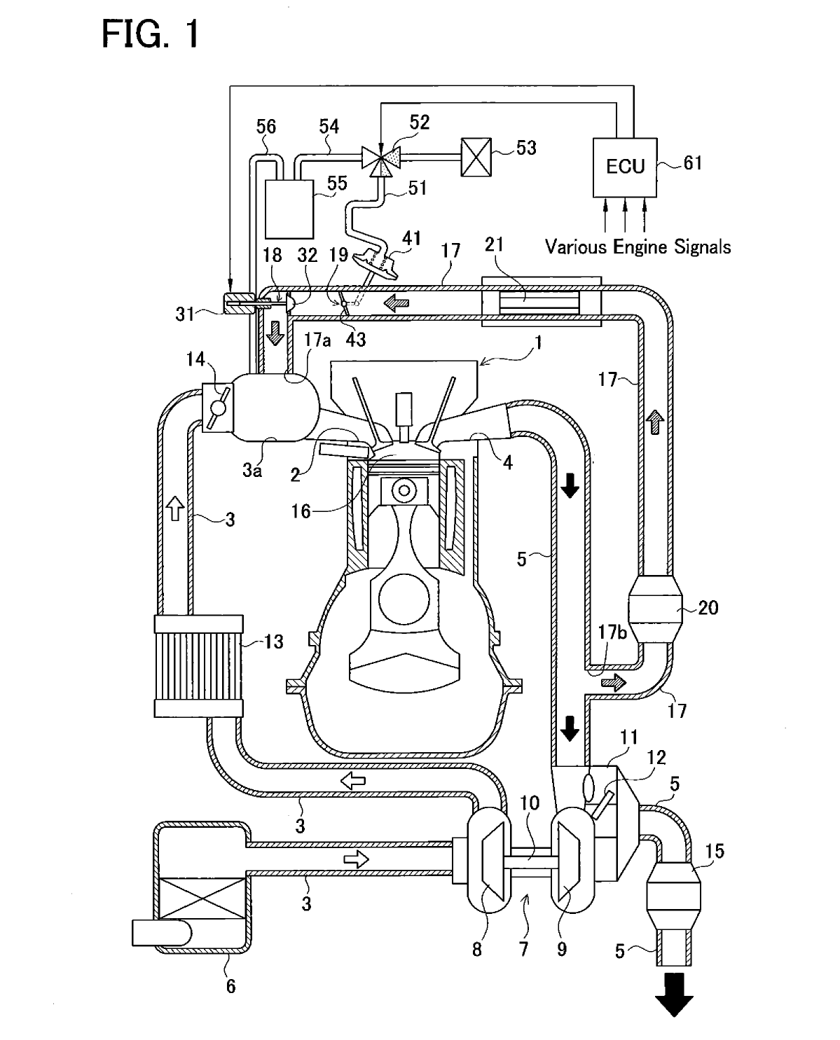

FIG. 1 is a schematic configuration view of an engine system with a supercharger including an exhaust gas recirculation (EGR) apparatus for engine in the present embodiment. This engine system includes a reciprocating-type engine 1. This engine 1 has an intake port 2 connected to an intake passage 3 and an exhaust port 4 connected to an exhaust passage 5. An air cleaner 6 is provided at an inlet of the intake passage 3. In the intake passage 3 downstream from the air cleaner 6, a supercharger 7 is placed in a position between a portion of the intake passage 3 and a portion of the exhaust passage 5 to raise the pressure of intake air in the intake passage 3.

The supercharger 7 includes a compressor 8 placed in the intake passage 3, a turbine 9 placed in the exhaust passage 5, and a rotary shaft 10 connecting the compressor 8 and the turbine 9 so that they are integrally rotatable. The supercharger 7 is configured to rotate the turbine 9 with exhaust gas flowing in the exhaust passage 5 and integrally rotate the compressor 8 through the rotary shaft 10 in order to increase the pressure of intake air in the intake passage 3, that is, carry out supercharging.

In the exhaust passage 5, adjacent to the supercharger 7, an exhaust bypass passage 11 is provided by detouring around the turbine 9. In this exhaust bypass passage 11, a waste gate valve 12 is placed. This waste gate valve 12 regulates exhaust gas allowed to flow in the exhaust bypass passage 11. Thus, a flow rate of exhaust gas to be supplied to the turbine 9 is regulated, thereby controlling the rotary speeds of the turbine 9 and the compressor 8, and adjusting supercharging pressure of the supercharger 7.

In the intake passage 3, an intercooler 13 is provided between the compressor 8 of the supercharger 7 and the engine 1. This intercooler 13 serves to cool intake air having the pressure raised by the compressor 8 and hence a high temperature, down to an appropriate temperature. A surge tank 3a is provided in the intake passage 3 between the intercooler 13 and the engine 1. Further, a throttle valve 14 is placed downstream from the intercooler 13 but upstream from the surge tank 3a. This throttle valve 14 is configured to adjust its opening degree according to operation of an accelerator pedal (not shown) by a driver. In the exhaust passage 5 downstream from the turbine 9, a catalytic converter 15 is provided as an exhaust catalyst to clean exhaust gas.

In the present embodiment, the EGR apparatus to achieve high EGR includes an exhaust gas recirculation passage (an EGR passage) 17 allowing a part of exhaust gas discharged from a combustion chamber 16 of the engine 1 to the exhaust passage 5 to flow in the intake passage 3 and recirculate back to the combustion chamber 16, and a first exhaust gas recirculation valve (a first EGR valve) 18 and a second exhaust gas recirculation valve (a second EGR valve) 19 arranged in series in the EGR passage 17 to regulate an exhaust flow rate (an EGR flow rate) in the EGR passage 17. The EGR passage 17 is provided to extend between the exhaust passage 5 upstream from the turbine 9 and the surge tank 3a. Specifically, an outlet 17a of the EGR passage 17 is connected to the surge tank 3a on a downstream side from the throttle valve 14 in order to allow a part of exhaust gas flowing in the exhaust passage 5 to flow as EGR gas into the intake passage 3 and recirculate to the combustion chamber 16. An inlet 17b of the EGR passage 17 is connected to the exhaust passage 5 upstream from the turbine 9.

In the vicinity of the inlet 17b of the EGR passage 17, an EGR catalytic converter 20 is provided to clean EGR gas. In the EGR passage 17 downstream from this EGR catalytic converter 20, an EGR cooler 21 is provided to cool EGR gas flowing in the EGR passage 17. In the present embodiment, the first EGR valve 18 and the second EGR valve 19 are located in the EGR passage 17 downstream from the EGR cooler 21. In the present embodiment, in the EGR passage 17, the first EGR valve 18 is located more downstream than the second EGR valve 19.

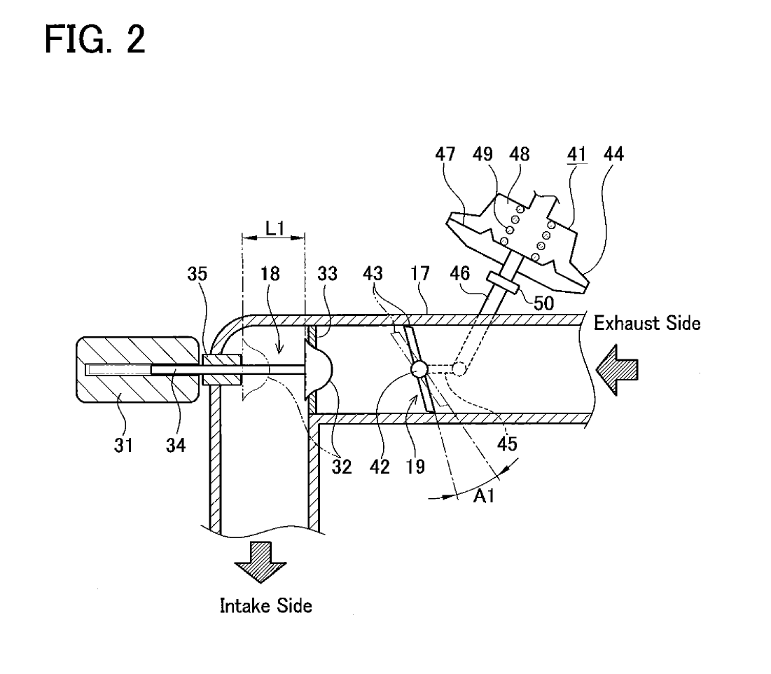

FIG. 2 is an enlarged cross sectional view of a part of the EGR passage 17, in which the first EGR valve 18 and the second EGR valve 19 are provided. As shown in FIGS. 1 and 2, the first EGR valve 18 is configured as a poppet valve and a motor-operated valve. To be concrete, the first EGR valve 18 is provided with a valve element 32 to be driven by a step motor 31. The valve element 32 has an almost conical shape and is configured to seat on a valve seat 33 provided in the EGR passage 17. The step motor 31 includes an output shaft 34 arranged to reciprocate in a straight line (stroke movement). The valve element 32 is fixed at a leading end of the output shaft 34. This output shaft 34 is supported in the EGR passage 17 through a bearing 35. The stroke movement of the output shaft 34 of the step motor 31 is performed to adjust the opening degree of the valve element 32 with respect to the valve seat 33. The output shaft 34 of the first EGR valve 18 is provided to allow stroke movement by a predetermined stroke L1 between a fully closed position in which the valve element 32 seats on the valve seat 33 and a fully opened position in which the valve element 32 contacts with the bearing 35. In the present embodiment, an opening area of the valve seat 33 is set larger than a conventional one in order to achieve high EGR. Accordingly, the valve element 32 is also designed with large size.

As shown in FIGS. 1 and 2, the second EGR valve 19 is configured as a butterfly valve and is configured to be driven by a diaphragm actuator 41. Specifically, the second EGR valve 19 includes a valve shaft 42 provided to rotatably extend across the EGR passage 17, a disc-like valve element 43 fixed on the valve shaft 42 in the EGR passage 17, and the diaphragm actuator 41 forming a drive mechanism.

The diaphragm actuator 41 includes a housing 44, a rod 46 coupled to the valve shaft 42 through a link 45, a diaphragm 47 connected to a base end of the rod 46, a negative-pressure chamber 48 partitioned by the diaphragm 47, and a spring 49 provided in the negative-pressure chamber 48 to urge the diaphragm 47. Unless no negative pressure is applied to the negative-pressure chamber 48, the diaphragm 47 is urged by the spring 49 to hold the rod 46 at a lowest end position. In this state, the valve element 43 is placed in a position (a fully closed position) to completely close the EGR passage 17 through the link 45, and the valve shaft 42. On the other hand, when a negative pressure is applied to the negative-pressure chamber 48, the diaphragm 47 and the rod 46 are pulled to be displaced against the urging force of the spring 49, thereby moving the rod 46 to an uppermost end position. In this state, the valve element 43 is placed in a position (a fully opened position) to fully open the EGR passage 17 through the link 45 and the valve shaft 42. In the present embodiment, a stopper 50 is provided in a predetermined position on the rod 46 so as to engage with the housing 44. This stopper 50 is configured to restrict a permissible maximum opening degree of the valve element 43 of the second EGR valve 19 to a predetermined small opening degree A1 smaller than full open, e.g., to a 30% opening degree of full open. The second EGR valve 19 is configured as above to change its opening degree in a range between the predetermined small opening degree and full close. In the present embodiment, the size (diameter) of the valve element 43 and the size (inner diameter) of the EGR passage 17 are determined so that the second EGR valve 19 held at the predetermined small opening degree A1 allows the first EGR valve 18 to provide a maximum exhaust flow rate (a maximum EGR flow rate). In the present embodiment, the maximum EGR flow rate by the first EGR valve 18 is set to a relatively high rate in order to execute EGR in every operating region of the engine 1 equipped with the supercharger 7. Accordingly, an opening stroke of the valve element 32 to bring the first EGR valve 18 to full open is set to a relatively large distance as indicated by a chain double-dashed line in FIG. 2. Therefore, when the first EGR valve 18 is to be controlled from full open to full close, it takes some time. In other words, the first EGR valve 18 tends to cause a slight delay in closing from full open to full close.

Herein, the characteristics of the first EGR valve 18 configured as the poppet valve and the second EGR valve 19 configured as the butterfly valve are compared. As for the maximum EGR flow rate during full open, the second EGR valve 19 is larger than the first EGR valve 18. As for the response speed from full open to full close, the second EGR valve 19 is faster than the first EGR valve 18. Concerning the controllability of EGR flow rate, the first EGR valve 18 is superior in a small flow rate region to the second EGR valve 19, whereas the second EGR valve 19 is superior in a large flow rate region to the first EGR valve 18. By controlling both the first EGR valve 18 and the second EGR valve 19, therefore, it is possible to set the EGR flow rate so as to gradually change in the small flow rate region and rapidly change in the large flow rate region. Regarding the flow rate characteristics, the opening area of the first EGR valve 18 during valve opening increases in a curved manner in proportion to its opening degree and the opening area of the second EGR valve 19 during valve opening increases in a linear manner in proportion to its opening degree.

As shown in FIGS. 1 and 2, the negative-pressure chamber 48 of the diaphragm actuator 41 is connected to a vacuum switching valve (VSV) 52 through a negative-pressure line 51. This VSV 52 is a constituent component of a drive mechanism for the second EGR valve 19 and is a three-way electromagnetic valve provided with an inlet port, an outlet port, and an ambient air port. The outlet port of the VSV 52 is connected to the negative-pressure line 51. At the ambient air port of the VSV 52, a filter 53 is provided. The inlet port of the VSV 52 is connected to an outlet port of a reserve tank 55 through the negative-pressure line 54. An inlet port of the reserve tank 55 is connected to the surge tank 3a through the negative-pressure line 56. During operation of the engine 1, negative pressure generated in the surge tank 3a acts on the reserve tank 55 through the negative-pressure line 56.

During operation of the engine 1, furthermore, when the VSV 52 is turned off, allowing the negative pressure to be supplied from the reserve tank 55 to the negative-pressure chamber 48 of the diaphragm actuator 41 through the negative-pressure line 54, VSV 52, and negative-pressure line 51. Thus, the diaphragm 47 and the rod 46 are displaced upward against the urging force of the spring 49, thereby opening the valve element 43 of the second EGR valve 19 to a maximum opening degree set at the predetermined small opening degree A1 as indicated by a chain double-dashed line in FIG. 2. When the VSV 52 is turned on, on other hand, the negative-pressure chamber 48 of the diaphragm actuator 41 is communicated with atmosphere through the negative-pressure line 51, VSV 52, and filter 53. Accordingly, the diaphragm 47 and the rod 46 are pushed down by the spring 49 to a lowest end position. The valve element 43 of the second EGR valve 19 thus comes to full close as indicated by a solid line in FIG. 2.

In the present embodiment, for controlling both the first EGR valve 18 and the second EGR valve 19 according to the operating state of the engine 1, the step motor 31 of the first EGR valve 18 and the VSV 52 of the second EGR valve 19 are controlled individually by an electronic control unit (ECU) 61. The ECU 61 includes a central processing unit (CPU), various memories for storing predetermined control programs and others in advance or temporarily storing calculation results of the CPU, and an external input circuit and an external output circuit each connected to the above sections. The ECU 61 corresponds to one example of a control unit of the present invention. The step motor 31 and the VSV 52 are connected to the external output circuit. Various sensors (not shown) for detecting the operating state of the engine 1 are connected to the external input circuit of the ECU 61, which receives various engine signals from the sensors. Herein, various engine signals representing the operating state of the engine 1 include detection signals from various sensors relating to engine rotation speed NE, engine load KL, throttle opening degree TA, engine cooling-water temperature THW, and others.

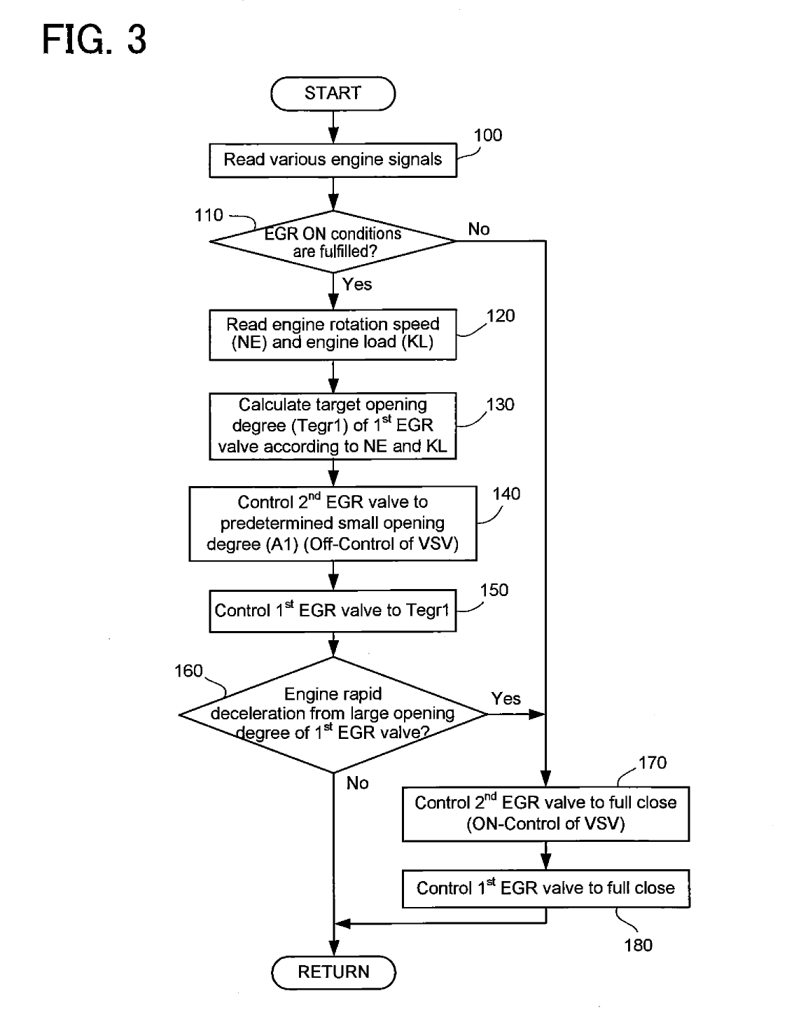

The following explanation is given to the processing contents of EGR control to be executed by the ECU 61 in the EGR apparatus configured as above. FIG. 3 is a flowchart showing one example of the processing contents of the EGR control.

When the processing shifts to this routine, the ECU 61 firstly reads, at step 100, various engine signals representing the operating state of the engine 1.

At step 110, subsequently, the ECU 61 determines whether or not the engine operating state fulfills an EGR ON condition. In other words, it is determined whether or not the operating state of the engine 1 is a state needing execution of EGR. If an answer at this step is No, the ECU 61 advances the processing to step 170 without executing EGR.

At step 170, the ECU 61 controls the VSV 52 to turn ON, thereby bringing the second EGR valve 19 to full close. Simultaneously, at step 180, the ECU 61 controls the step motor 31 to bring the first EGR valve 18 to full close.

On the other hand, if an answer at step 110 is Yes, the ECU 61 advances the processing to step 120 to execute EGR.

At step 120, the ECU 61 reads the engine rotation speed NE and the engine load KL.

At step 130, the ECU 61 calculates a target opening degree Tegr1 of the first EGR valve 18 based on the engine rotation speed NE and the engine load KL. The ECU 61 calculates this target opening degree Tegr1 by referring to an opening degree map (not shown) presenting previously set function data.

At step 140, subsequently, the ECU 61 controls the VSV 52 to turn OFF, thereby bringing the second EGR valve 19 to the predetermined small opening degree A1 which is the maximum opening degree.

At step 150, the ECU 61 controls the step motor 31 to bring the first EGR valve 18 into the target opening degree Tegr1.

At step 160, the ECU 61 determines whether or not the operating state of the engine 1 is engine rapid deceleration from a large opening degree of the first EGR valve 18. If No at this step, the ECU 61 returns the processing to step 100. If Yes at this step, the ECU 61 advances the processing to step 170 and executes the above processings at steps 170 and 180 to immediately stop EGR.

According to the EGR apparatus of the present embodiment explained above, during operation of the engine 1 but non-operation of the supercharger 7, when both the first EGR valve 18 and the second EGR valve 19 are in respective open positions, the negative pressure generated in the surge tank 3a downstream from the throttle valve 14 acts on the outlet 17a of the EGR passage 17, sucking part of the exhaust gas flowing in the exhaust passage 5 into the surge tank 3a as EGR gas through the EGR catalytic converter 20, the EGR passage 17, and the EGR cooler 21. During non-operation of the supercharger 7, therefore, an appropriate flow rate of EGR gas is allowed to flow in the intake passage 3 through the EGR passage 17 and return to the combustion chamber 16. At that time, the EGR flow rate in the EGR passage 17 can be arbitrarily regulated by appropriately controlling the opening degrees of the first EGR valve 18 and the second EGR valve 19.

During operation of the engine 1 and operation of the supercharger 7, on the other hand, when both the first EGR valve 18 and the second EGR valve 19 are in respective open positions, surpercharged exhaust pressure in the exhaust passage 5 acts on the inlet 17b of the EGR passage 17, pushing part of the exhaust gas flowing in the exhaust passage 5 into the surge tank 3a as EGR gas through the EGR catalytic converter 20, EGR passage 17, and EGR cooler 21. During operation of the supercharger 7, therefore, an appropriate flow rate of EGR gas is allowed to flow in the intake passage 3 through the EGR passage 17 and return to the combustion chamber 16. At that time, the EGR flow rate in the EGR passage 17 can be arbitrarily regulated by appropriately controlling the opening degrees of the first EGR valve 18 and the second EGR valve 19.

According to the present embodiment, the first EGR valve 18 is configured as the poppet valve. In general, the characteristics of EGR flow rate determined by opening/closing of the first EGR valve 18 gradually changes according to an opening degree. When the opening degree of the first EGR valve 18 is controlled while the second EGR valve 19 is open, it is accordingly possible to gradually change and regulate the EGR flow rate in the EGR passage 17. On the other hand, the second EGR valve 19 is configured as the butterfly valve. The EGR flow rate which can be regulated by the butterfly valve is larger than that by the poppet valve. Thus, the second EGR valve 19 achieves a faster response speed from full open to full close than the first EGR valve 18. Consequently, controlling the second EGR valve 19 to rotate from the maximum opening degree to full close can rapidly shut off the flow of EGR in the EGR passage 17. In the present embodiment, therefore, both the first EGR valve 18 and the second EGR valve 19 are controlled to gradually change the EGR flow rate in a small flow rate region of intake air and rapidly change the EGR flow rate in a large flow rate region of intake air in order to regulate the EGR flow rate.

According to the present embodiment, the first EGR valve 18 is arranged to open in a range of opening degree from full open to full close, and the second EGR valve 19 is arranged to open up to the predetermined small opening degree A1 set as the maximum opening degree, which is smaller than full open. Therefore, when the engine 1 enters a rapid deceleration mode and thereby the first EGR valve 18 is controlled to operate from the large opening degree (e.g., full open) to full close and the second EGR valve 19 is controlled to operate from the maximum opening degree, i.e., the predetermined small opening degree A1, to full close, the second EGR valve 19 can be brought to full close earlier than the first EGR valve 18.

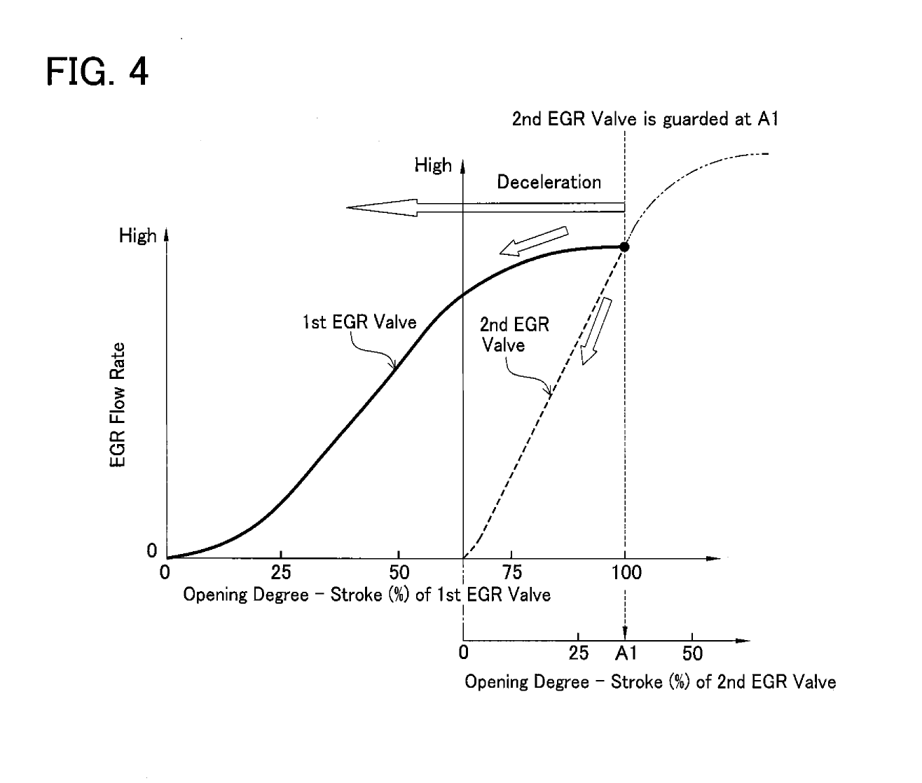

Herein, FIG. 4 is a graph showing a relationship between opening degree and stroke of the first EGR valve 18, opening degree and stroke of the second EGR valve 19, and EGR flow rate. FIG. 4 shows a state where, when the first EGR valve 18 is held in full open (100%) and the second EGR valve 19 is held in the predetermined small opening degree A1 (e.g., 30%) set as the maximum opening degree, the EGR valves 18 and 19 are controlled individually to come into full close (0%) by rapid deceleration of the engine 1. Herein, the first EGR valve 18 provides the EGR flow rate characteristic that the flow rate causes a relatively large change in a region of small flow-rate/small opening degree but a relatively small change in a region of large flow-rate/large opening degree. While the first EGR valve 18 is fully open, accordingly, even when the first EGR valve 18 is operated towards full close according to rapid deceleration of the engine 1, the first EGR valve 18 delays in closing. In contrast, the second EGR valve 19 is operated from the maximum opening degree set to the predetermined small opening degree A1, not from full open, to full close. In addition, the second EGR valve 19 has a faster opening/closing response property than the first EGR valve 18. Thus, the second EGR valve 19 is brought to full close more rapidly than the first EGR valve 18. In FIG. 4, specifically, when the first EGR valve 18 reaches an about 60% opening degree in the course of movement towards full close, the second EGR valve 19 comes to full close. As a result, the EGR passage 17 is rapidly closed by the second EGR valve 19, thus promptly blocking off a flow of EGR. In the present embodiment, as above, it is possible to precisely regulate a high EGR flow rate in the EGR passage 17 by use of the first EGR valve 18 and the second EGR valve 19 arranged in series in the EGR passage 17 and also immediately shut off the high EGR during rapid deceleration of engine 1. This can avoid deceleration and accidental firing of the engine 1 due to the delay in stopping high EGR. In addition, the diaphragm actuator 41 and the VSV 52 which have been heretofore used as a drive mechanism are simply used to promptly bring the second EGR valve 19 to full close, so that upsizing of the drive mechanism and enhancing of drive power of the drive mechanism can be restrained.

In the present embodiment, when the second EGR valve 19 is at the predetermined small opening degree A1 and the first EGR valve 18 is full open, a maximum EGR flow rate provided by the first EGR valve 18 is ensured as a maximum EGR flow rate in the EGR passage 17. Accordingly, the high EGR can be controlled by making full use of the flow rate characteristics of the first EGR valve 18.

In the present embodiment, the first EGR valve 18 is configured as the motor-operated valve and the second EGR valve 19 is configured as be driven by the diaphragm actuator 41. Accordingly, the first EGR valve 18 reflects the controllability resulting from the motor-operated valve and the second EGR valve 19 reflects the controllability resulting from the diaphragm actuator 41. Specifically, since the first EGR valve 18 is configured as the motor-operated valve, its opening degree can be changed continuously. Since the second EGR valve 19 is driven by the diaphragm actuator 41, its opening/closing response ability can be enhanced. Thus, by controlling both the first EGR valve 18 and the second EGR valve 19, it is possible to gradually change and regulate the high EGR flow rate mainly by the first EGR valve 18 and promptly start and stop of EGR mainly by the second EGR valve 19.

In the present embodiment, the first EGR valve 18 is placed in the EGR passage 17 downstream from the second EGR valve 19. After the second EGR valve 19 located on an upstream side is fully closed, the first EGR valve 18 located on a downstream side is less likely to be influenced by exhaust gas. Accordingly, during stop of EGR, the first EGR valve 18 can be protected from exhaust gas.

### Second Embodiment

A second embodiment of an exhaust gas recirculation apparatus for engine according to the present invention will be described below referring to the accompanying drawings.

Similar or identical parts in each of the following embodiments to those in the first embodiment are assigned with the same reference signs as those in the first embodiment and not explained hereinafter. The following explanation is made with a focus on differences from the first embodiment.

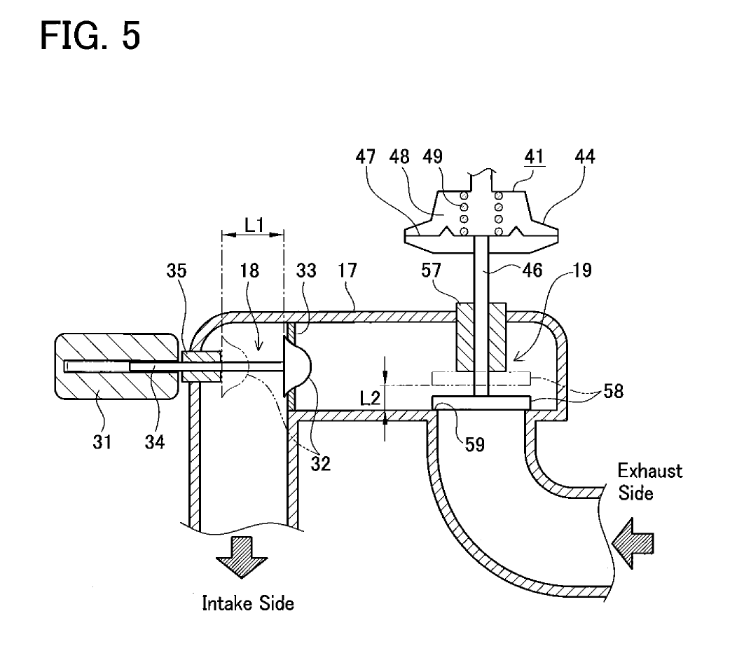

FIG. 5 is an enlarged cross sectional view of a part of the EGR passage 17 in which the first EGR valve 18 and the second EGR valve 19 are provided. The present embodiment differs from the first embodiment in that the second EGR valve 19 is configured as a poppet valve to be driven by the diaphragm actuator 41, as shown in FIG. 5. The rod 46 of the diaphragm actuator 41 is supported in the EGR passage 17 through a bearing 57. A lower end of the rod 46 is fixed with a flat-plate-like valve element 58. This valve element 58 is configured to seat on a valve seat 59 formed in the EGR passage 17.

In the present embodiment, the output shaft 34 of the first EGR valve 18 is arranged to make stroke movement by a predetermined stroke L1 between a fully closed position and a fully opened position. On the other hand, the second EGR valve 19 is arranged to open up to a predetermined small opening degree A1 set as a maximum opening degree, which is smaller than full open. Specifically, the rod 46 of the diaphragm actuator 41 is provided to perform stroke movement by a predetermined stroke L2 between a fully closed position where the valve element 58 seats on the valve seat 59 and the predetermined small opening degree A1 at which the valve element 58 abuts on the bearing 57. An inherent allowable stroke of the rod 46 in the diaphragm actuator 41 is longer than the stroke L2. However, in the present embodiment, the bearing 57 is designed to be long in an axial direction to set the maximum opening degree of the valve element 58 to the predetermined small opening degree A1, thereby allowing the valve element 58 to early contact with a lower end of the bearing 57. Thus, the stroke movement of the rod 46 is restricted to the stroke L2 smaller than the inherent maximum stroke. In the present embodiment, furthermore, the valve seat 59 of the second EGR valve 19 is formed with a relatively large opening area and also the valve element 58 is formed with a relatively large surface area in order to allow the first EGR valve 18 to provide a maximum EGR flow rate. In the present embodiment, the stroke L2 of the rod 46 of the second EGR valve 19 is set to be distinctly smaller than the stroke L1 of the output shaft 34 of the first EGR valve 18. In the present embodiment, as with the first embodiment, the negative-pressure lines 51, 54, and 56, VSV 52, filter 53, reserve tank 55, and others related to the diaphragm actuator 41 are provided.

According to the EGR apparatus of the present embodiment, therefore, in which the second EGR valve 19 is configured as the poppet valve to be driven by the diaphragm actuator 41, so that the link 45 provided between the valve element 43 and the rod 46 in the first embodiment can be eliminated. Other operations and effects in the present embodiment are similar to those in the first embodiment.

### Third Embodiment

A third embodiment of an exhaust gas recirculation apparatus for engine according to the present invention will be described below referring to the accompanying drawings.

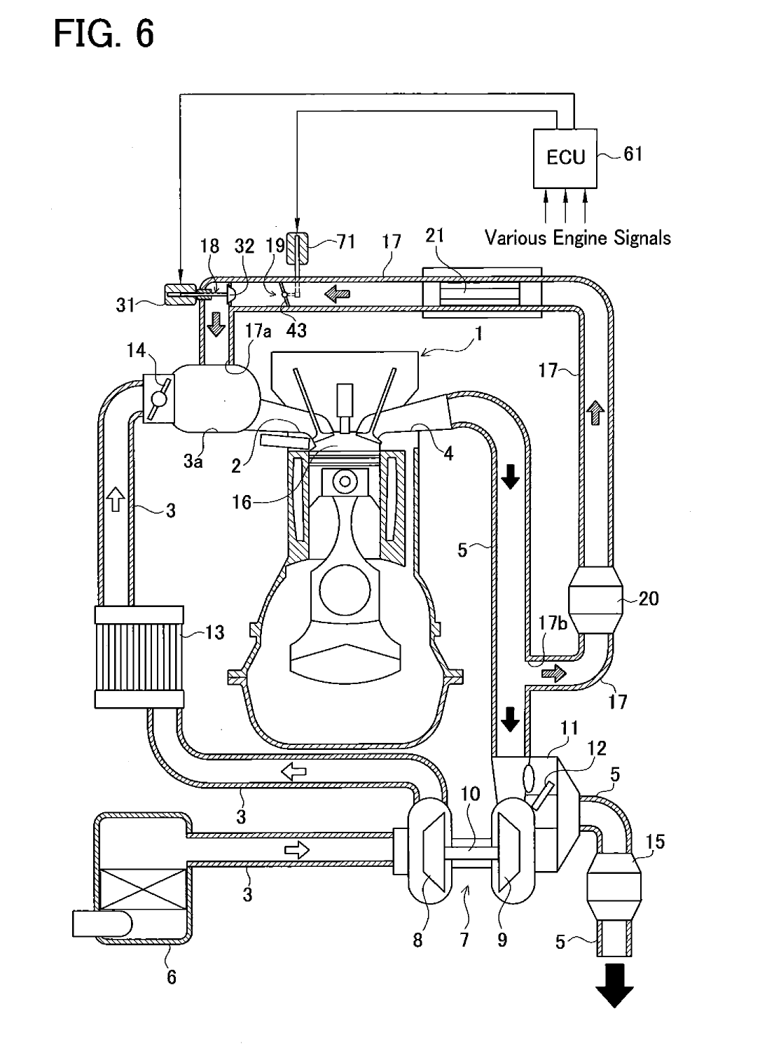

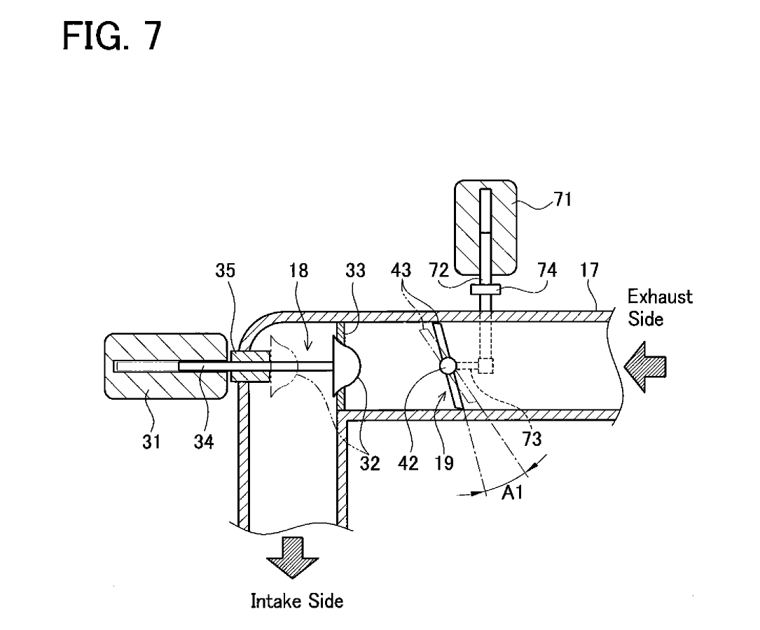

FIG. 6 is a schematic configuration view of an engine system with a supercharger including an EGR apparatus of the present embodiment. FIG. 7 is an enlarged cross sectional view of a part of the EGR passage 17 in which the first EGR valve 18 and the second EGR valve 19 are provided. As shown in FIGS. 6 and 7, the present embodiment differs from the first embodiment in that the second EGR valve 19 is a motor-operated valve. In the present embodiment, specifically, the second EGR valve 19 configured as a butterfly valve is driven by a step motor 71. As shown in FIG. 7, an output shaft 72 of the step motor 71 configured to perform linear stroke movement is coupled to the valve shaft 42 through a link 73. By stroke movement of the output shaft 72 of the step motor 71, the opening degree of the valve element 43 is adjusted.

In the present embodiment, when the output shaft 72 of the step motor 71 is pushed down to a lowest end position as shown in FIG. 7, the valve element 43 of the second EGR valve 19 is brought to a fully closed position through the link 73 and the valve shaft 43. When this output shaft 72 is pulled up back to an uppermost end position, the valve element 43 of the second EGR valve 19 is placed in a fully opened position. In the present embodiment, however, the permissible maximum opening degree of the second EGR valve 19 is restricted to a predetermined small opening degree A1 (e.g., 30%) smaller than full open. To be concrete, a stopper 74 is provided in a predetermined position on the output shaft 72 so as to engage with a lower end of a housing of the step motor 71. When the stopper 74 abuts against the lower end of the housing of the step motor 71, the opening degree of the valve element 43 of the second EGR valve 19 is restricted to the predetermined small opening degree A1. The size (diameter) of the valve element 43 of the second EGR valve 19 and the size (inner diameter) of the EGR passage 17 are determined so that the first EGR valve 18 provide a high rate of a maximum EGR flow rate when the second EGR valve 19 is held at the predetermined small opening degree A1. In the present embodiment, the step motor 71 is controlled to adjust the stroke movement of the output shaft 72, thereby continuously changing the opening degree of the valve element 43 of the second EGR valve 19 in a range between the fully closed position and the predetermined small opening degree A1.

In the present embodiment, as shown in FIG. 6, the step motors 31 and 71 are each connected to the external output circuit of the ECU 61. Various sensors (not shown) for detecting the operating state of the engine are connected to the external output circuit of the ECU 61 which receives various engine signals from the sensors.

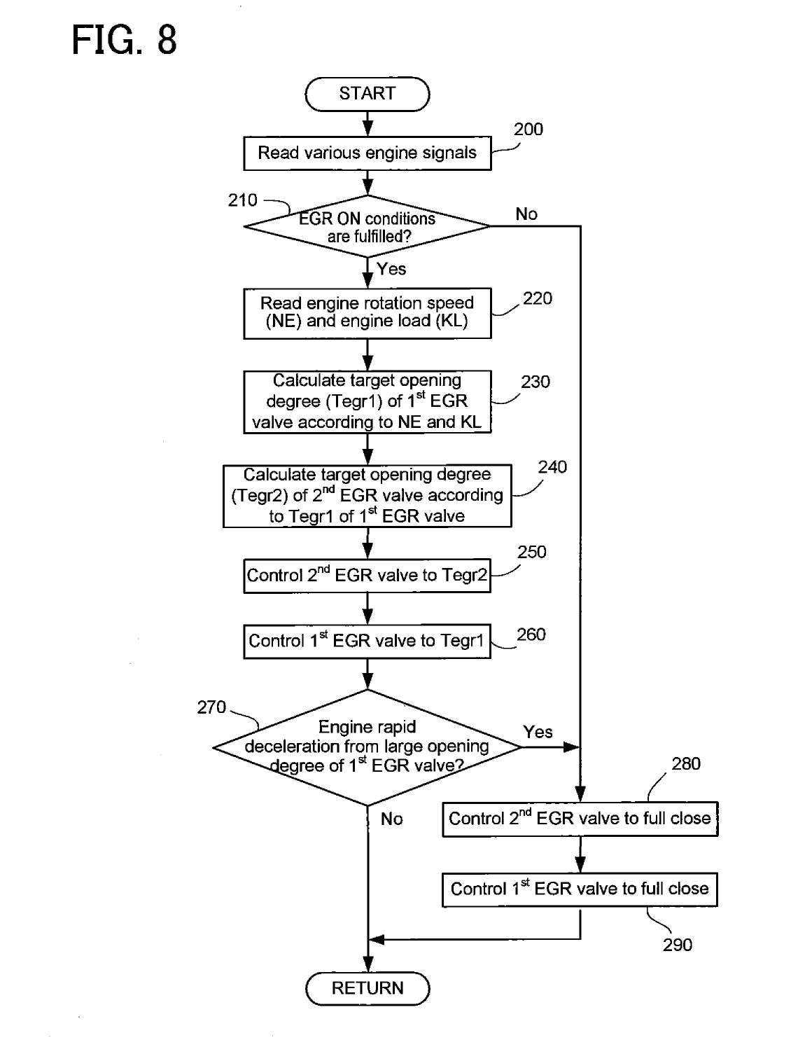

The processing contents of EGR control to be executed by the ECU 61 in the EGR apparatus configured as above will be explained below. FIG. 8 is a flowchart showing one example of the processing contents of the EGR control.

When the processing shifts to this routine, the ECU 61 firstly reads, at step 200, various engine signals representing the operating state of the engine 1.

At step 210, subsequently, the ECU 61 determines whether or not the engine operating state fulfills an EGR ON condition. In other words, it is determined whether or not the operating state of the engine 1 is a state needing execution of EGR. If an answer at this step is No, the ECU 61 advances the processing to step 280 without executing EGR.

At step 280, the ECU 61 controls the step motor 71 to bring the second EGR valve 19 to full close. At step 290, subsequently, the ECU 61 controls the step motor 31 to bring the first EGR valve 18 to full close.

On the other hand, if an answer at step 210 is Yes, the ECU 61 advances the processing to step 220 to execute EGR.

At step 220, the ECU 61 then reads the engine rotation speed NE and the engine load KL.

At step 230, the ECU 61 calculates a target opening degree Tegr1 of the first EGR valve 18 according to the engine rotation speed NE and the engine load KL. The ECU 61 calculates this target opening degree Tegr1 by referring to an opening degree map (not shown) presenting previously set function data.

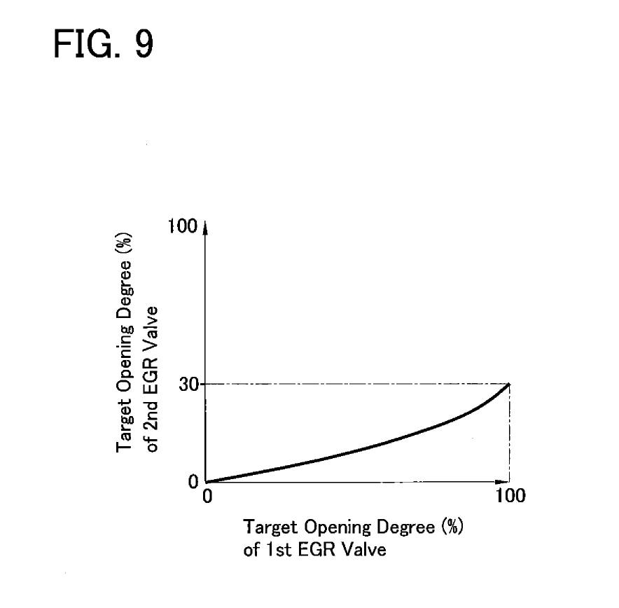

At step 240, the ECU 61 calculates a target opening degree Tegr2 of the second EGR valve 19 according to the target opening degree Tegr1 of the first EGR valve 18. The ECU 61 calculates this target opening degree Tegr2 by referring to the opening degree map shown in FIG. 9 representing the previously set function data. In the opening degree map shown in FIG. 9, the target opening degree Tegr2 of the second EGR valve 19 is set so as to change in a curved manner in a range of 0% to 30% in association with the target opening degree Tegr1 of the first EGR valve 18 changing in a range of 0% to 100%. Accordingly, when the target opening degree Tegr1 of the first EGR valve 18 is full open (100%), the target opening degree Tegr2 of the second EGR valve 19 is calculated as the maximum opening degree set at the predetermined small opening degree A1 (e.g., 30%). Alternatively, when the target opening degree Tegr1 of the first EGR valve 18 is smaller than full open (100%), the target opening degree Tegr2 of the second EGR valve 19 is also calculated as a smaller value than the predetermined small opening degree A1 (e.g., 30%).

At step 250, the ECU 61 then controls the step motor 71 to open the second EGR valve 19 to the target opening degree Tegr2.

At step 260, the ECU 61 further controls the step motor 31 to open the first EGR valve 18 to the target opening degree Tegr1.

At step 270, the ECU 61 determines whether or not the operating state of the engine 1 is engine rapid deceleration from the large opening degree of the first EGR valve 18. If No at this step, the ECU 61 returns the processing to step 200. If Yes at this step, the ECU 61 advances the processing to step 280 and executes the above processings at steps 280 and 290 to immediately stop EGR.

According to the EGR apparatus of the present embodiment explained above, the opening degree of the second EGR valve 19 is controlled by the ECU 61 according to the opening degree of the first EGR valve 18 to regulate the EGR flow rate in the EGR passage 17. Therefore, when the first EGR valve 18 is controlled to operate from full open to full close, the second EGR valve 19 is controlled to rotate from the maximum opening degree, i.e., the predetermined small opening degree A1 (e.g., 30%), to full close as in the first embodiment. When the first EGR valve 18 is controlled to operate from a smaller opening degree (e.g., 75%) than full open to full close, the second EGR valve 19 is controlled to rotate from an opening degree A1-α smaller by a predetermined value a than the predetermined small opening degree A1 (e.g., 30%) set as the maximum opening degree towards full close. Accordingly, depending on the opening degree of the first EGR valve 18, the second EGR valve 19 can be brought to full close reliably earlier than the first EGR valve 18. Thus, when the opening degree of the first EGR valve 18 is changed from the opening degree smaller than full open to full close, the time needed to bring the second EGR valve 19 to full close can be shortened.

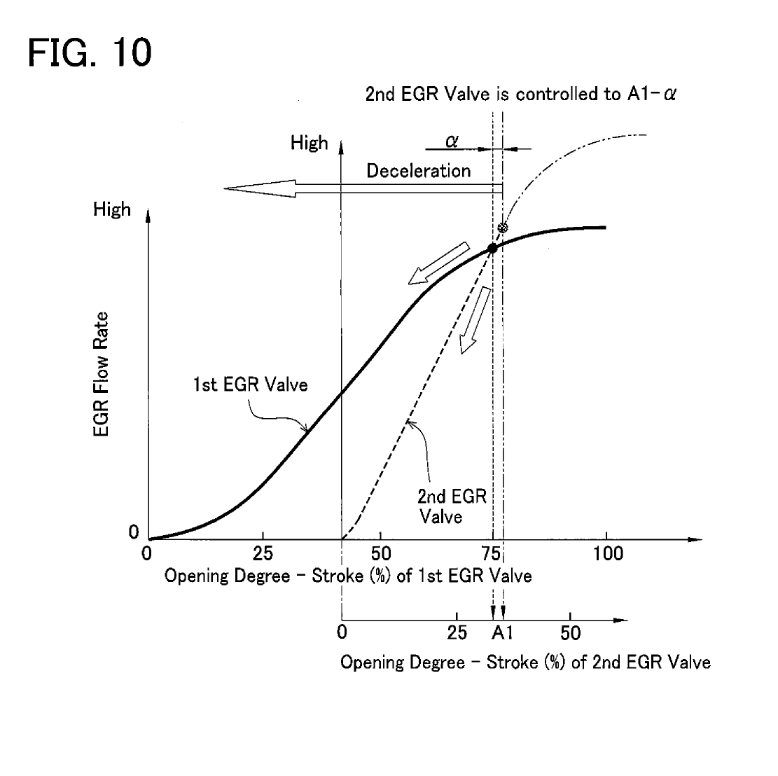

Herein, FIG. 10 is a graph showing a relationship between opening degree and stroke of the first EGR valve 18, opening degree and stroke of the second EGR valve 19, and

EGR flow rate. FIG. 10 shows a state where the first EGR valve 18 held in the opening degree (e.g., 75%) smaller than full open (100%) is controlled to be brought to full close according to rapid deceleration of the engine 1. At that time, the second EGR valve 19 is controlled to rotate from the predetermined small opening degree A1-α which is smaller by the predetermined value a than the predetermined small opening degree A1 (e.g., 30%) set as the maximum opening degree towards full close. Even when the first EGR valve 18 delays in closing at that time, the second EGR valve 19 is rotated from the predetermined small opening degree A1-α smaller by the predetermined value a than the predetermined small opening degree A1 set as the maximum opening degree to full close and also the second EGR valve 19, having a faster opening/closing response property than the first EGR valve 18, can come to full close faster than the first EGR valve 18. In other words, in FIG. 10, when the first EGR valve 18 is at about 40% opening degree from full open towards full close, the second EGR valve 19 is full close (0%). Thus, the EGR passage 17 is completely closed promptly by the second EGR valve 19 and EGR is shut off rapidly. In the present embodiment, as above, it is possible to precisely regulate a high EGR flow rate in the EGR passage 17 by use of the first EGR valve 18 and the second EGR valve 19 arranged in series in the EGR passage 17. Furthermore, during rapid deceleration of the engine 1, EGR can be shut off immediately. This can avoid accidental firing of the engine 1 during deceleration due to the delay in stopping high EGR. In addition, since the step motor 71 having been heretofore used as a drive mechanism for the second EGR valve 19 is simply used to rapidly bring the second EGR valve 19 to full close, upsizing of the drive mechanism and enhancing of driving power of the drive mechanism can be restrained.

In the present embodiment, the first EGR valve 18 is configured as the motor-operated valve and the second EGR valve 19 is configured as the motor-operated valve. Accordingly, the opening degree of the first EGR valve 18 and the opening degree of the second EGR valve 19 can be continuously changed. Therefore, the EGR flow rate in the EGR passage 17 can be more precisely controlled.

### Fourth Embodiment

A fourth embodiment of an exhaust gas recirculation apparatus for engine according to the present invention will be described below referring to the accompanying drawing.

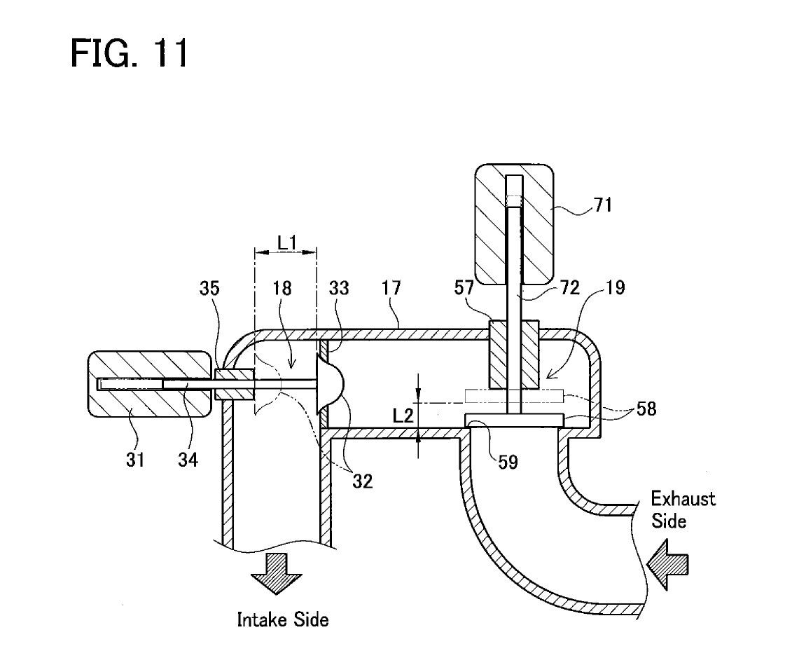

FIG. 11 is an enlarged cross sectional view of a part of the EGR passage 17 in which the first EGR valve 18 and the second EGR valve 19 are provided. The present embodiment differs from the third embodiment in that the second EGR valve 19 is constructed as a poppet valve and a motor-operated valve as shown in FIG. 11. The output shaft 72 of the step motor 71 of the second EGR valve 19 is supported in the EGR passage 17 through the bearing 57. A relationship in configuration among the valve element 58, the valve seat 59, the bearing 57, and the output shaft 72 in the second EGR valve 19 of the present embodiment is identical to a relationship in configuration among the valve element 58, the valve seat 59, the bearing 57, and the rod 46 of the second EGR valve 19 of the second embodiment. Other configurations are identical to those in the third embodiment.

In the EGR apparatus of the present embodiment, consequently, in which the second EGR valve 19 is configured as the poppet valve, the link 73 provided between the valve element 43 and the output shaft 72 in the third embodiment can be eliminated. The flow rate characteristics of the poppet valve gradually change according to the opening degree as compared to the butterfly valve. Thus, the second EGR valve 19 can regulate the EGR flow rate more precisely than the butterfly valve.

### Fifth Embodiment

A fifth embodiment of an exhaust gas recirculation apparatus for engine according to the present invention will be described below referring to the accompanying drawing.

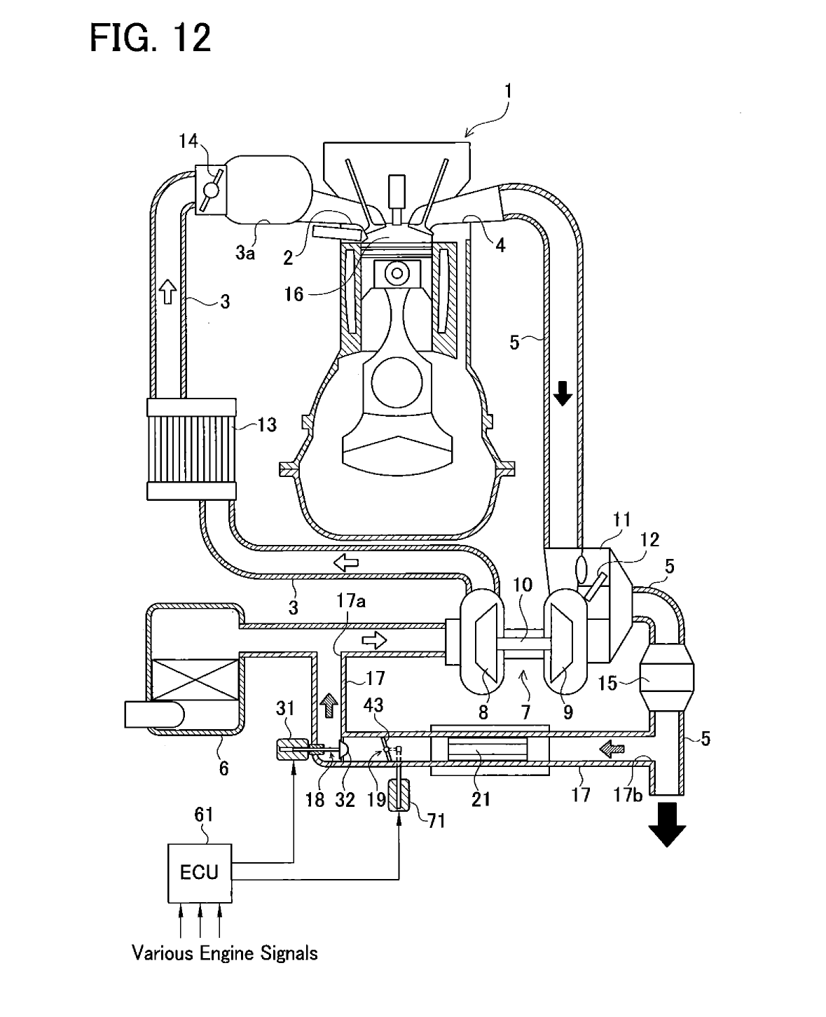

FIG. 12 is a schematic configuration view of an engine system with a supercharger including an EGR apparatus of the present embodiment. The present embodiment differs in placement of the EGR apparatus from the third embodiment as shown in FIG. 12. Specifically, in the present embodiment, the EGR passage 17 is connected, at its inlet 17b, to a part of the exhaust passage 5 downstream from the catalytic converter 15 and connected, at its outlet 17a, to a part of the intake passage 3 upstream from the compressor 8. Other configurations are identical to those in the third embodiment.

According to the present embodiment, during operation of the engine 1 and operation of the supercharger 7, when both the first EGR valve 18 and the second EGR valve 19 are in respective opened positions, the negative pressure generated in the intake passage 3 upstream from the compressor 8 by supercharged intake pressure acts on the outlet 17a of the EGR passage 17, thus sucking part of the exhaust gas flowing in the exhaust passage 5 downstream from the catalytic converter 5 into the intake passage 3 through the EGR passage 17, the EGR cooler 21, the second EGR valve 19, and the first EGR valve 18. Herein, the catalytic converter 15 functions as a resistance, so that the exhaust pressure is reduced to some extent on a downstream side of the catalytic converter 15 even though it is a high supercharged region. Accordingly, EGR can be performed by making the negative pressure generated by the supercharged intake pressure act on the EGR passage 17 even in the high supercharged region. Since a part of exhaust gas cleaned by the catalytic converter 15 is introduced into the EGR passage 17, the EGR catalytic converter 20 can be eliminated from the EGR passage 17 as compared to the first embodiment.

The present invention is not limited to the above embodiments and may be embodied in other specific forms without departing from the essential characteristics thereof.
(1) In each of the above embodiments, in the EGR passage 17, the first EGR valve 18 is placed more downstream than the second EGR valve 19. Alternatively, as shown in

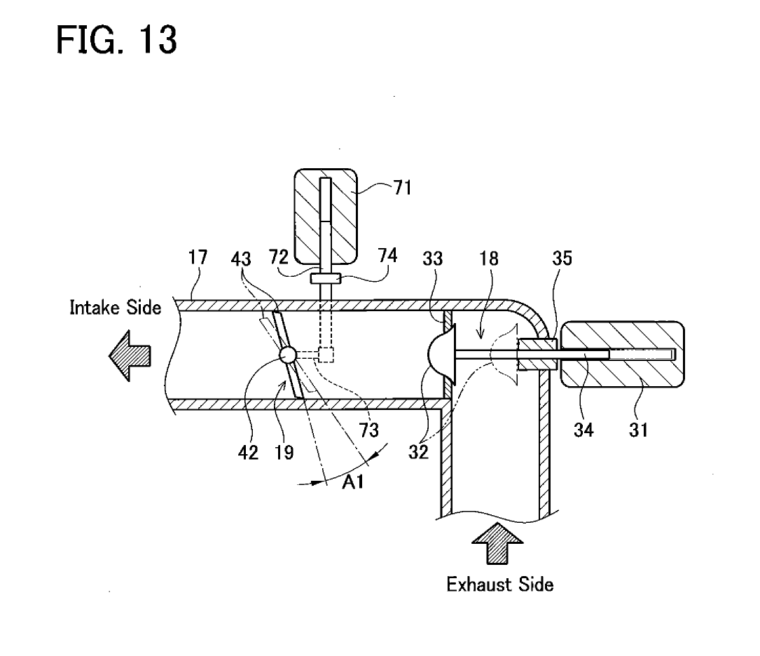

FIG. 13, the first EGR valve 18 may be placed more upstream than the second EGR valve 19 in the EGR passage 17. In this case, after the first EGR valve 18 located on the upstream side is fully closed, the second EGR valve 19 located on the downstream side is less likely to be influenced by exhaust gas. During stop of EGR, therefore, the second EGR valve 19 can be protected from the exhaust gas.
(2) In each of the above embodiments, the EGR apparatus of the present invention is embodied in the engine 1 equipped with the supercharger 7. Alternatively, the EGR apparatus of the present invention may be embodied in an engine equipped with no supercharger.

(3) In the second and fourth embodiments mentioned above, in order to set the maximum opening degree of the valve element 58 to the predetermined small opening degree A1, the bearing 57 is designed to be long in the axial direction so that the valve element 58 early comes into contact with the lower end of the bearing 57, thereby restricting the stroke movement of the rod 46 of the diaphragm actuator 41 to the stroke L2. As an alternative, a predetermined stopper may be provided to restrict displacement of the diaphragm 47 of the diaphragm actuator 41 to restrict the stroke movement of the rod 46 of the diaphragm actuator 41 to the stroke L2.

While the presently preferred embodiment of the present invention has been shown and described, it is to be understood that this disclosure is for the purpose of illustration and that various changes and modifications may be made without departing from the scope of the invention as set forth in the appended claims.

### INDUSTRIAL APPLICABILITY

The present invention can be utilized in for example a vehicle engine irrespective of a gasoline engine or a diesel engine.

### REFERENCE SIGNS LIST

1 Engine

3 Intake passage

3a Surge tank

5 Exhaust passage

7 Supercharger

8 Compressor

9 Turbine

10 Rotary shaft

14 Throttle valve

15 Catalytic converter (Exhaust catalyst)

16 Combustion chamber

17 EGR passage (Exhaust gas recirculation passage)

17a Outlet

17b Inlet

18 First EGR valve (First exhaust gas recirculation valve)

19 Second EGR valve (Second exhaust gas recirculation valve)

31 Stepping motor

32 Valve element

41 Diaphragm actuator

43 Valve element

52 VSV

61 ECU (Control unit)

71 Step motor

A1 Predetermined small opening degree

1. An exhaust gas recirculation apparatus for engine comprising: an exhaust gas recirculation passage for allowing a part of exhaust gas discharged from a combustion chamber of an engine to an exhaust passage to flow in an intake passage and recirculate to the combustion chamber; and a first exhaust gas recirculation valve and a second exhaust gas recirculation valve provided in series in the exhaust gas recirculation passage to regulate a flow rate of the exhaust gas in the exhaust gas recirculation passage,
wherein the first exhaust gas recirculation valve is configured as a poppet valve and is configured to open in a range of opening degree from full open to full close, and
the second exhaust gas recirculation valve has a maximum opening degree restricted to a predetermined small opening degree smaller than full open and is configured to open in a range of opening degree from the predetermined small opening degree to fill close.

2. The exhaust gas recirculation apparatus for engine according to claim 1, wherein the second exhaust gas recirculation valve is configured to allow the first exhaust gas recirculation valve to provide a maximum exhaust flow rate when the second exhaust gas recirculation valve is held at the predetermined small opening degree.

3. The exhaust gas recirculation apparatus for engine according to claim 1, further including a control unit to control the first exhaust gas recirculation valve and the second exhaust gas recirculation valve respectively to regulate the flow rate of the exhaust gas in the exhaust gas recirculation passage and control the opening degree of the second exhaust gas recirculation valve according to the opening degree of the first exhaust gas recirculation valve.

4. The exhaust gas recirculation apparatus for engine according to claim 2, further including a control unit to control the first exhaust gas recirculation valve and the second exhaust gas recirculation valve respectively to regulate the flow rate of the exhaust gas in the exhaust gas recirculation passage and control the opening degree of the second exhaust gas recirculation valve according to the opening degree of the first exhaust gas recirculation valve.

5. The exhaust gas recirculation apparatus for engine according to claim 1, wherein the second exhaust gas recirculation valve includes a butterfly valve.

6. The exhaust gas recirculation apparatus for engine according to claim 1, wherein the second exhaust gas recirculation valve is configured as a poppet valve.

7. The exhaust gas recirculation apparatus for engine according to claim 1, wherein the first exhaust gas recirculation valve includes a motor-operated valve and the second exhaust gas recirculation valve is configured to be driven by a diaphragm actuator.

8. The exhaust gas recirculation apparatus for engine according to claim 1, wherein the first exhaust gas recirculation valve includes a motor-operated valve and the second exhaust gas recirculation valve includes a motor-operated valve.

9. The exhaust gas recirculation apparatus for engine according to claim 1, wherein the first exhaust gas recirculation valve is placed more downstream than the second exhaust gas recirculation valve in the exhaust gas recirculation passage.

10. The exhaust gas recirculation apparatus for engine according to claim 1, wherein the first exhaust gas recirculation valve is placed more upstream than the second exhaust gas recirculation valve in the exhaust gas recirculation passage.

11. The exhaust gas recirculation apparatus for engine according to claim 1,
wherein a supercharger is provided in a position between a portion of the intake passage and a portion of the exhaust passage,
a throttle valve is provided in the intake passage downstream from the supercharger, and
the exhaust gas recirculation passage has an inlet connected to the exhaust passage upstream from the supercharger and an outlet connected to the intake passage downstream from the throttle valve.

12. The exhaust gas recirculation apparatus for engine according to claim 1,
wherein a supercharger is provided in a position between a portion of the intake passage and a portion of the exhaust passage,
a throttle valve is provided in the intake passage downstream from the supercharger,
an exhaust catalyst is provided in the exhaust passage downstream from the supercharger, and
the exhaust gas recirculation passage has an inlet connected to the exhaust passage downstream from the exhaust catalyst and an outlet connected to the intake passage upstream from the supercharger.

13. An exhaust gas recirculation apparatus for engine comprising: an exhaust gas recirculation passage for allowing a part of exhaust gas discharged from a combustion chamber of an engine to an exhaust passage to flow in an intake passage and recirculate to the combustion chamber; and a first exhaust gas recirculation valve and a second exhaust gas recirculation valve provided in series in the exhaust gas recirculation passage to regulate a flow rate of the exhaust gas in the exhaust gas recirculation passage,
wherein the first exhaust gas recirculation valve is configured as a poppet valve and is configured to open in a range of opening degree from full open to full close,
the second exhaust gas recirculation valve has a maximum opening degree restricted to a predetermined small opening degree smaller than full open and is configured to open in a range of opening degree from the predetermined small opening degree to full close,
the second exhaust gas recirculation valve is configured to allow the first exhaust gas recirculation valve to provide a maximum exhaust flow rate when the second exhaust gas recirculation valve is at the predetermined small opening degree,
the second exhaust gas recirculation valve includes a butterfly valve,
the first exhaust gas recirculation valve is placed more downstream than the second exhaust gas recirculation valve in the exhaust gas recirculation passage,
a supercharger is provided in a position between a portion of the intake passage and a portion of the exhaust passage,
a throttle valve is provided in the intake passage downstream from the supercharger, and
the exhaust gas recirculation passage has an inlet connected to the exhaust passage upstream from the supercharger and an outlet connected to the intake passage downstream from the throttle valve.

14. The exhaust gas recirculation apparatus for engine according to claim 13, further including a control unit to control the first exhaust gas recirculation valve and the second exhaust gas recirculation valve respectively to regulate the flow rate of the exhaust gas in the exhaust gas recirculation passage and control the opening degree of the second exhaust gas recirculation valve according to the opening degree of the first exhaust gas recirculation valve.

15. The exhaust gas recirculation apparatus for engine according to claim 13, wherein the first exhaust gas recirculation valve includes a motor-operated valve and the second exhaust gas recirculation valve is configured to be driven by a diaphragm actuator.

16. The exhaust gas recirculation apparatus for engine according to claim 13, wherein the first exhaust gas recirculation valve includes a motor-operated valve and the second exhaust gas recirculation valve includes a motor-operated valve.

17. An exhaust gas recirculation apparatus for engine comprising: an exhaust gas recirculation passage for allowing a part of exhaust gas discharged from a combustion chamber of an engine to an exhaust passage to flow in an intake passage and recirculate to the combustion chamber; and a first exhaust gas recirculation valve and a second exhaust gas recirculation valve provided in series in the exhaust gas recirculation passage to regulate a flow rate of the exhaust gas in the exhaust gas recirculation passage,
wherein the first exhaust gas recirculation valve is configured as a poppet valve and is configured to open in a range of opening degree from full open to full close,
the second exhaust gas recirculation valve has a maximum opening degree restricted to a predetermined small opening degree smaller than full open and is configured to open in a range of opening degree from the predetermined small opening degree to full close,
the second exhaust gas recirculation valve is configured to allow the first exhaust gas recirculation valve to provide a maximum exhaust flow rate when the second exhaust gas recirculation valve is at the predetermined small opening degree,
the second exhaust gas recirculation valve includes a butterfly valve,
the first exhaust gas recirculation valve is placed more downstream than the second exhaust gas recirculation valve in the exhaust gas recirculation passage,
a supercharger is provided in a position between a portion of the intake passage and a portion of the exhaust passage,
a throttle valve is provided in the intake passage downstream from the supercharger,
an exhaust catalyst is provided in the exhaust passage downstream from the supercharger, and
the exhaust gas recirculation passage has an inlet connected to the exhaust passage downstream from the exhaust catalyst and an outlet connected to the intake passage upstream from the supercharger.

18. The exhaust gas recirculation apparatus for engine according to claim 17, further including a control unit to control the first exhaust gas recirculation valve and the second exhaust gas recirculation valve respectively to regulate the flow rate of the exhaust gas in the exhaust gas recirculation passage and control the opening degree of the second exhaust gas recirculation valve according to the opening degree of the first exhaust gas recirculation valve.

19. The exhaust gas recirculation apparatus for engine according to claim 17, wherein the first exhaust gas recirculation valve includes a motor-operated valve and the second exhaust gas recirculation valve is configured to be driven by a diaphragm actuator.

20. The exhaust gas recirculation apparatus for engine according to claim 17, wherein the first exhaust gas recirculation valve includes a motor-operated valve and the second exhaust gas recirculation valve includes a motor-operated valve.
